(19) United States
(12) Patent Application Publication
(10) Pub. No.: US 2007/0156783 A1
(43) Pub. Date: Jul. 5, 2007

(54) Message life-cycle management policies and administration

(75) Inventors: Julian Alexander Zbogar-Smith, Redmond, WA (US); Jaya Matthew, Seattle, WA (US); Robert Combs, Redmond, WA (US); Jason Mayans, Bothell, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/325,031

(22) Filed: Jan. 4, 2006

(51) Int. Cl. G06F 17/30

(52) U.S. Cl. 707/203

(57) ABSTRACT

Systems that provide users with a model for designing, implementing, complying with, and proving compliance with, message life cycle management policies are disclosed. Such a model may be based on the notion of folders upon which policies are defined, new restrictions on such folders, mechanisms to assure that users have such folders, and mechanisms to establish how well users are complying with the policies by determining how they are filing items into the folders. The concept can be extended to other mutually exclusive grouping mechanisms.

### BACKGROUND

Electronic messages such as e-mail and instant messages have become a dominant form of communication in most businesses today. Because they have become so ubiquitous and so critical to every phase of business, proper management of such messages has become essential. High profile legal and regulatory cases have been won and lost on the basis of electronic messages that have been incorrectly retained, and managed.

A key technical inhibitor to companies avoiding such problems in the future is a lack of policy-based, cohesive message life-cycle management capabilities. Enforcing a life-cycle management policy manually tends to be cumbersome and ineffective. Systems that automatically enforce such policies, however, typically do not respect content. Ensuring that important items are kept is often difficult. There is often no advanced warning of expiring items, and a user can typically recover expired items from a “dumpster.”

In existing systems, message life-cycle management is typically a layer atop the message store and hence can provide limited functionality and few guarantees that the policies are being enforced. For example, a message deletion request that goes directly against the store without going through the message life-cycle management software may delete a message that has specifically been requested to be preserved. Furthermore, the policies are often so complicated that users cannot easily comply with them. Even if they could, there is typically no efficient way to tell whether users are following a policy.

Another shortcoming of existing systems is that discovery tends to be time-consuming and expensive. Discovery refers to searching for certain items or classes of items, typically in response to a request for same in the context of litigation or a regulatory-related action. Discovery tends to be difficult because e-mails tend to be numerous and exist in many different locations.

### SUMMARY

Systems that provide users with a model for designing, implementing, complying with, and proving compliance with message life cycle management policies are described and claimed herein. Such a model may be based on the notion of “folders” upon which policies are defined, new restrictions on such folders, mechanisms to assure that users have such folders, and mechanisms to establish how well users are complying with such policies by determining how the users are filing items into the folders. It should be understood that the concept can be extended to other grouping mechanisms. Such grouping mechanisms may be mutually exclusive, though it is possible to have overlapping grouping mechanisms and to enforce multiple policies on a single item.

A folder may be the unit of policy definition and enforcement. This is the most simple and intuitive message grouping mechanism available to users and therefore the mechanism with which it is easiest for them to comply. Such folders may be automatically created by a daemon process on a regular basis so all users routinely get the updated set of folders into which they should be classifying items such as e-mail messages, calendar items, notes, etc. Such folders may have special properties imparted to them by the fact that they are part of the message lifecycle system. Policies on those folders, such as retention and deletion rules, may supersede not only the user's request but also any rules or policies put on them by another mechanism.

An email life cycle system as disclosed herein may allow users to classify content by dragging items into special “Organizational” folders in the mailbox used for filing e-mail. An “Organizational” folder, as that term is used herein, refers to a folder that is used for the purposes of classifying items in order to ensure that the appropriate email lifecycle policies are enforced. An Organizational folder may have a quota associated with it. A system administrator may create an Organizational folder and “push” it into a user's mailbox. The system may provide a web page list of folders from which a user can select. Thus, an Organizational folder may be chosen by the user.

Policies may be configurable by a system administrator. E-mail that is no longer needed may be deleted, with configurable expiration policies. E-mail that needs to be kept may be retained by copying it to a “repository.” A “repository,” as that term is used herein, refers to a controlled storage location for the purpose of maintaining items in compliance with a policy. Summary reports may be provided to show how well users are complying with life-cycle management policy. A discovery tool may be provided for performing enhanced searches.

### BRIEF DESCRIPTION OF THE DRAWINGS

FIG. 1 is a flowchart of an example method for management and administration of message life-cycle management policies and administration.

FIG. 2 depicts a user interface for creating a new e-mail lifecycle folder.

FIGS. 3 and 4 depict user interfaces for creating new e-mail lifecycle content settings.

FIG. 5 depicts linking the settings for an ELC folder to the settings for a mailbox.

FIG. 6 depicts a user interface for adding an organizational folder to a mailbox.

FIG. 7 depicts a user interface for displaying an ELC assistant schedule.

FIG. 8 depicts a mailbox folder display including a number of Organizational folders.

FIG. 9 depicts a user interface that enables a user to classify content.

FIG. 10 depicts a user interface for a discovery tool.

FIG. 11 is a block diagram showing an example computing environment in which aspects of the invention may be implemented.

### DETAILED DESCRIPTION

Mailbox folders are a natural way for users to classify important information. Accordingly, as disclosed herein, an “Organizational” folder may be the way in which messages are grouped for policy enforcement. The creation of grouping mechanisms for messages may include: 1) the collections to which policies are applied; 2) policies that can be applied to that grouping; and 3) mechanisms to prove adherence to the policies.

An Organizational folder, may have several special properties. First, policies may be associated with Organizational folders (similar to the way in which properties are applied to folders in a general file system, or by storing the information in a corporate metadata repository such as LDAP, or Active Directory). Second, only an administrator can change the policy settings on these folders. Third, users may be prevented from renaming, moving, or (in most cases) deleting this folder type. Fourth, an administrator can enter a URL or text describing the policy. The e-mail lifecycle service (ELC) will then stamp this information on the folders in the user's mailbox and the messaging client can display this text to the user. This enables administrators to inform users about general corporate e-mail lifecycle policies as well as information about policies that apply to “Organizational” folders in a natural and intuitive manner. Fifth, a scheduled service may scan the metadata repository settings and compare to the settings in the user's mailbox. The service may install new folders into the user's mailbox as dictated in the metadata repository, change policy settings in the mailbox if the setting in the metadata repository have changed, and rename the mailbox folder if the folder name has changed. By creating this simple model, companies can enforce standard records management policies on the folders uniformly across the company, deploy certain policy folders administratively to users, and prevent these folders from being modified or deleted by the user.

In some businesses, however, a records administrator cannot handle the work load to determine the folders needed by each user. As a result, users may also be given a mechanism whereby they can allocate an “Organizational” folder to their mailbox. While the user has this folder, the company's policies are enforced upon it. Since the user requested the folder, he/she may be allowed to delete it whenever the user deems it necessary. However, the user may not be allowed to rename or move the folder.

The following are examples of policies that can be defined on content grouped via an “Organizational” folder. An “AutoCopy” policy may be provided whereby messages may be copied on a per-folder basis to an alternate message repository, which may support SMTP. This enables certain messages to be retained for a specific period of time regardless of user action, or action to that user.

A “Review Before Deletion” or “cascading expiration” policy may be provided for creating a compliant records-management policy that demonstrates due diligence in retaining information. Accordingly, it may be desirable to provide a mechanism by which items that will be removed in the near future are highlighted in some way, allowing the user to review and take action to keep any needed items. For example, users may be given the ability to review messages that will be deleted in the near future before the disposal occurs by moving message to be delete into a “Cleanup Review” folder (the folder name is configurable) from its original location in the mailbox. The message may remain in this folder for a specific period of time during which the user may review and save any needed items before they are automatically deleted. Optionally, the E-mail Lifecycle service can send warning e-mails to users giving them information about the items that will expire in the near future. Administrators can customize these warning e-mails by customizing the subject and report text.

An “Expiration” policy may be provided whereby messages that are no longer needed for business or regulatory reasons are automatically disposed of on a per-folder basis once they reach a certain age. This prevents them from taking up space and increasing message management costs or surviving past their designated expiration time.

A “Preservation” policy may be provided whereby messages may be retained in the user's mailbox on a per-folder basis. The user cannot delete these messages until they reach the end of its retention period.

A “per-folder quota” policy may be provided to limit the amount of data that may be placed in a folder and its subfolders. This enables much more fine-grained storage quota support to allow administrators to controls how users utilize their mailbox storage in the presence of E-mail Lifecycle folders.

To establish a baseline set of policies for “everything else,” a policy can be created that applies to all folders for which a policy has not already been defined.

Any or all of the above-described policies may be applied, by default, to any message in the associated folder. However, different message types often require different policies. For example, an e-mail related to a certain subject may need to be retained for three years, whereas a voicemail attachment may be considered useful only for 90 days. It may be desirable, therefore, that multiple policy entries can be created for the same folder if they each specify different message classes. Hence there can be a policy for e-mail and another for voice mails.

Another policy would be restricting deletion of messages from a “dumpster.” It is common in messaging systems to support a “dumpster,” into which deleted items are placed temporarily. This allows users to quickly recover these items from accidental deletion errors. It is also used as an alternate mechanism to retain messages for a longer period of time by ensuring that messages remain in the system long enough to be captured by a backup process. A “dumpster” is also useful for companies that wish to recover messages during investigations of corporate policy violations. Today a user can delete an item from their mailbox and then delete it from their “dumpster,” negating the aforementioned benefits. Preventing users from deleting items from the dumpster protects these benefits.

To track compliance, one may record when an item was filed into an “Organizational” folder. Providing the information as to when an item was categorized helps to demonstrate that a company's recordkeeping practices are accurate and compliant.

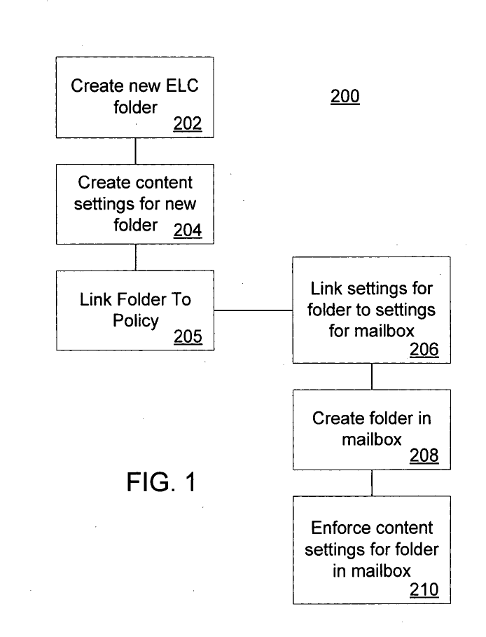

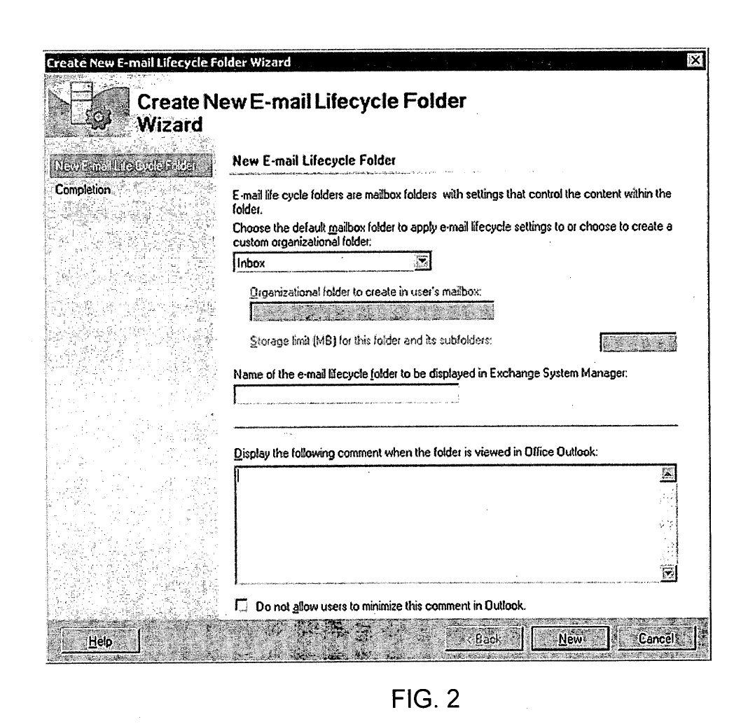

FIG. 1 is a flowchart of an example method 200 for management and administration of message life-cycle management policies and administration. At 202, a new ELC mailbox folder may be created. FIG. 2 depicts a user interface for creating a new ELC folder. An email lifecycle folder is a folder in a mailbox with settings that control the content the folder contains. As shown in FIG. 2, a user, such as a system administrator, can choose a default mailbox folder (e.g., Inbox) to apply e-mail lifecycle settings to, or the administrator can create a custom Organizational folder. The administrator can supply a name for the folder, and a storage limit for the folder and its subfolders. The administrator can also supply a name for the e-mail lifecycle folder to be displayed. The administrator can also supply the text of a comment that can be displayed when the folder is viewed in the document viewer or e-mail client. The administrator can indicate (such as by checking or unchecking a box, for example) whether end-users should be allowed to minimize the comment when the folder is viewed in Outlook. After the administrator supplies the information, the administrator can cause the system to create the folder by clicking the “Create” button. The user interface may also include a “Cancel” button that enables the administrator to cancel the creation of an ELC folder, and a “Help” button that causes the system to provide explanatory information to the administrator.

At 204, ELC content settings are created for the folder. ELC content settings may provide a way to control the lifespan of items within a specified message type. For example, a content setting may be created to cause items to expire based on age and to be automatically copied to another location for storage. Content settings may also provide a manner to copy in item to an archive, as discussed below. It should be understood that the concept of content settings may be generalized to the enforcement of some type of policy upon items tied together by some sort of grouping mechanism (e.g., a folder).

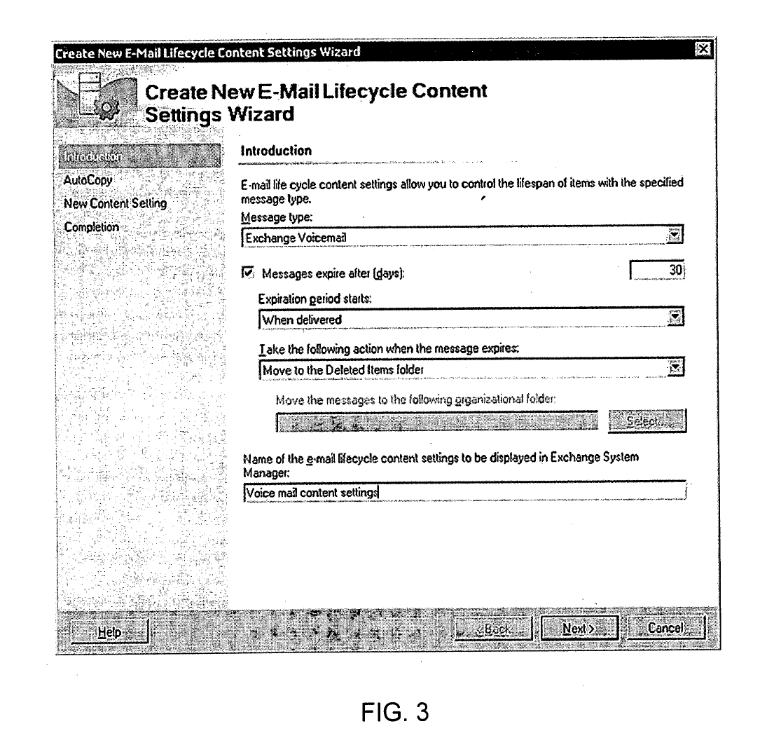

FIGS. 3 and 4 depict user interfaces for creating new e-mail lifecycle content settings. As shown in FIG. 3, the administrator may supply a message type (e.g., voicemail). The administrator may also supply an expiration period (i.e., a period after which the message is deemed “expired”). The period may be specified in days, for example, or any other unit of time. The administrator may define when the expiration period starts (e.g., when the item is moved to the folder), and may specify an action to be taken when the message expires (e.g., permanently delete the item). The administrator may also specify the name of an Organizational folder to which the messages should be moved upon expiration. The administrator may supply a name for the ELC content settings to be displayed in the Microsoft Exchange System Manager. The user interface may also include a “Cancel” button that enables the administrator to cancel the creation of content settings, a “Help” button that causes the system to provide explanatory information to the administrator, and a “Next” button that enables the administrator to move onto a next screen.

As shown in FIG. 4, the administrator may select whether to automatically forward a copy of items of the specified message type to another location (e.g., by checking/unchecking a box, for example). The administrator may supply a name associated with the location (e.g., a name of a folder to which the items are to be autocopied). The administrator can assign a label to the copy of the message, and specify a message format associated with the message. The user interface may also include a “Cancel” button that enables the administrator to cancel the creation of content settings, a “Help” button that causes the system to provide explanatory information to the administrator, a “Next” button that enables the administrator to move onto a next screen, and a “Back” button that enables the administrator to move back to a previous screen.

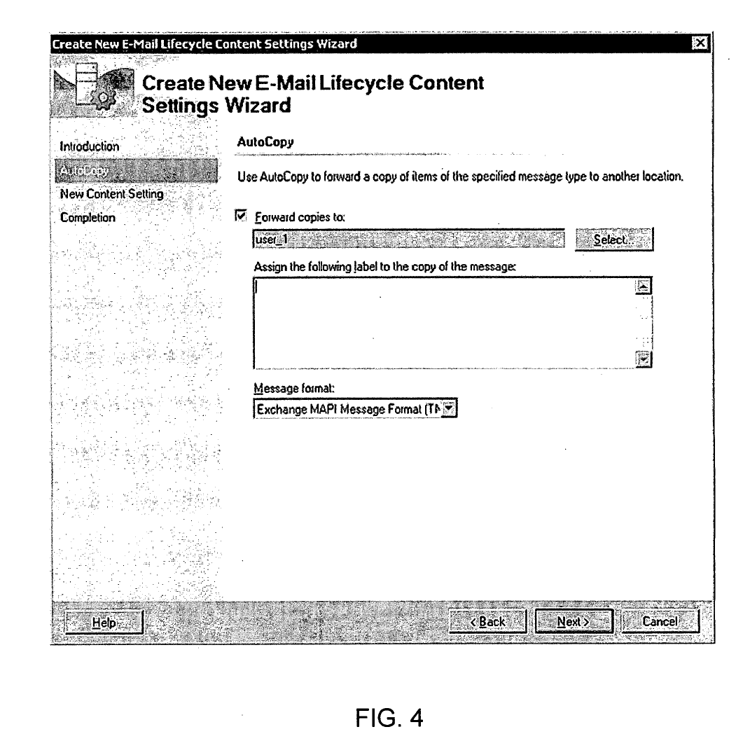

At 205, the folder may be linked to a policy, which is effectively a grouping mechanism for folders. This policy is then applied to a mailbox, at 206, by linking the settings for the folder to the settings for the mailbox. As shown in FIG. 5, settings associated with a mailbox 300 may be defined at 302. A new mailbox policy, which is used to group folders, may be created at 304. The new folders may then be linked to the mailbox policy at 306. The mailbox policy may then be applied to the mailbox 300 at 308. Thus, a link may be formed from the folder and content settings, via the policy, to the mailbox settings. As shown, the mailbox 300 may include a default folder (e.g., Inbox) 310 and an Organizational Folder (e.g., Legal Docs) 320. A first set of content settings 312 may be defined for the default folder 310 (e.g., delete all e-mails after 365 days). A second set of content settings 322 may be defined for the Organization folder 320 (e.g., copy all voicemails to archive).

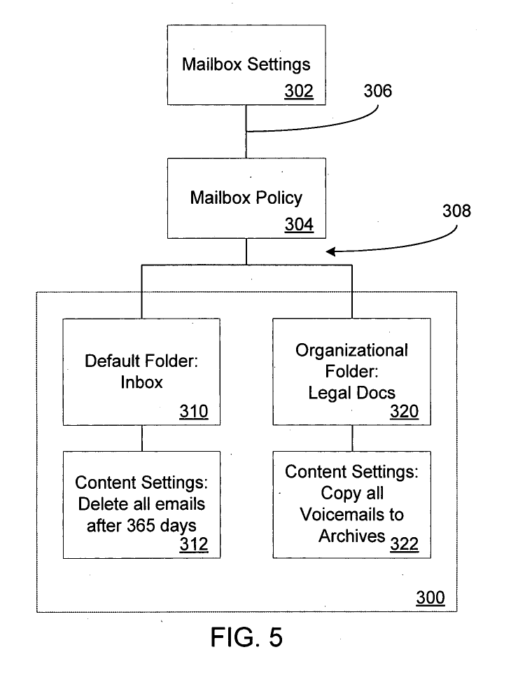

The administrator may “push” the folders to the mailbox, or the end-user may pull one or more Organizational folders into his or her mailbox. To pull folders, the end-user may navigate to a user-interface, such as an opt-in web page, for example, that enables the user to select from a number of available Organizational Folders. An example of such a user interface is depicted in FIG. 6. As shown, the end-user may be presented with a list of available Organizational folders. Each such folder may have an associated name. The user interface may also provide a respective description of each of the available folders. The description may be provided in any language, such as Latin, for example, and the language in which the description is given need not be the same as the language in which the name is given. The end-user can select one or more folders to be added to the end-user's mailbox by checking respective boxes associated with the folders to be added. The user interface may include a button that the end-user can select to cause the system to add the selected folders to the end-user's mailbox.

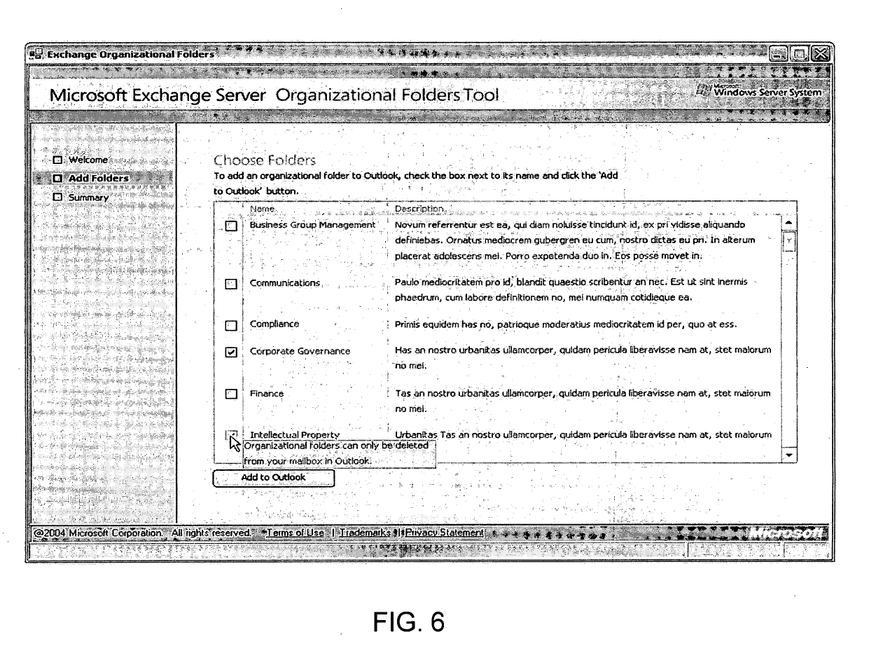

The ELC service may then be instructed to act upon these settings by creating, at 208, the appropriate folders in the mailbox and enforcing, at 210, the life-cycle management policies associated with those folders. The ELC service may launch an “ELC assistant,” according to a schedule, to enforce the life-cycle management policies. FIG. 7 depicts a user interface for displaying and defining such a schedule. The system administrator can define any desired schedule accordingly to which the ELC assistant is to run.

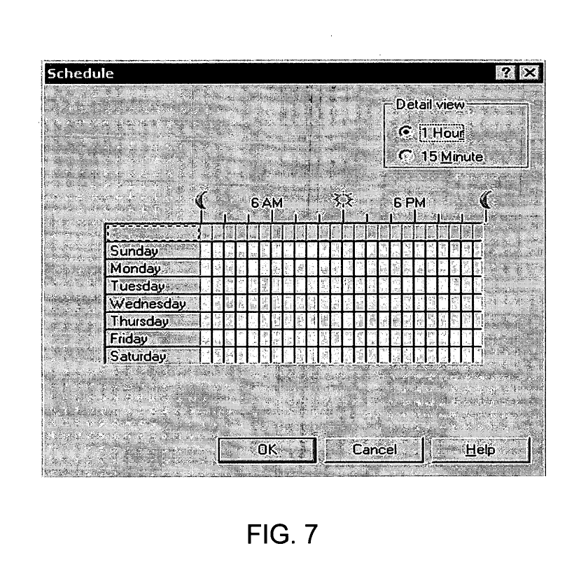

If the end-user selected one or more Organizational folders to be added to the mailbox, the selected folders may be added immediately upon the end-user's selection of the “Add to Outlook” button. If the system administrator arranged for the folders to be pushed to the end-user's mailbox, the next time the ELC assistant runs, the ELC assistant will create the necessary folders in the mailbox. FIG. 8 depicts an end-user's mailbox folder display after a number of Organizational folders have been added to the end-user's mailbox. As shown, for example, one or more Organizational folders (e.g., Business Critical Long T, Business Value, Client Contracts, and Pilot Plans) may exist under a collective folder named “My Organizational Folders.”

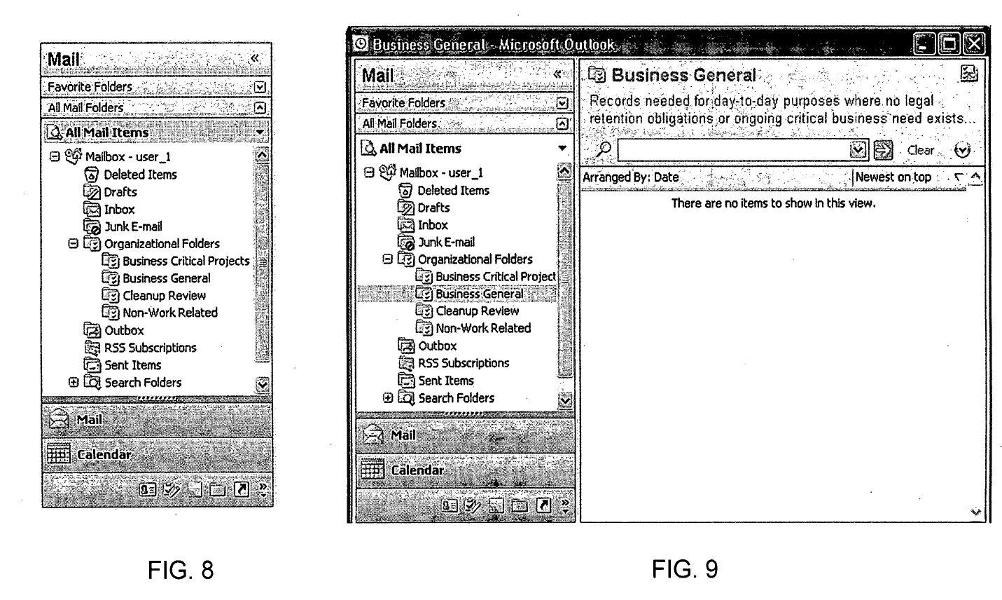

FIG. 9 depicts a user interface that enables a user to classify content. As described above, Organizational folders may be provisioned in mailboxes. Preferably, these folders cannot be moved, renamed, or deleted. Lifecycle management policies may be enforced on a per-folder basis. A user may classify items by dragging them into folders. As described above, Outlook can display a description of the policy, as shown in FIG. 9.

Each time the ELC assistant is run, it determines which emails are no longer needed (i.e., have expired) and which need to be kept. E-mails that have expired can be deleted. Expiration policies may be configurable per message type (e.g., e-mail, appointment, voicemail, etc.) within a folder and may be based on message age/size. Policy actions may include deleting a message (which may include permanently deleting an item, or moving a “deleted” item to a location from which it may be recovered), moving a message to another folder, marking a message as expired, and logging only. Optionally, an e-mail listing soon-to-be-deleted items can be sent out to all end-users of the mailbox system, or to those end-users whose mailboxes have items that are soon to be deleted. A log listing each expired item may be maintained.

E-mails that need to be kept can be autocopied to a repository (i.e., Exchange, SharePoint, or KVS, for example). An item sent to the repository may be stamped with a label to note how it was classified. A log listing each autocopied item may be maintained.

Logs can be maintained, and summary reports can be provided, to show the extent of (non)compliance with the lifecycle management policies. Logs may be kept locally, or in a Microsoft Office Manager or system center for data consolidation and viewing. Reports can include statistics to show the number of items and amount of data in different e-mail filing folders. Users who are not following a policy can also be listed.

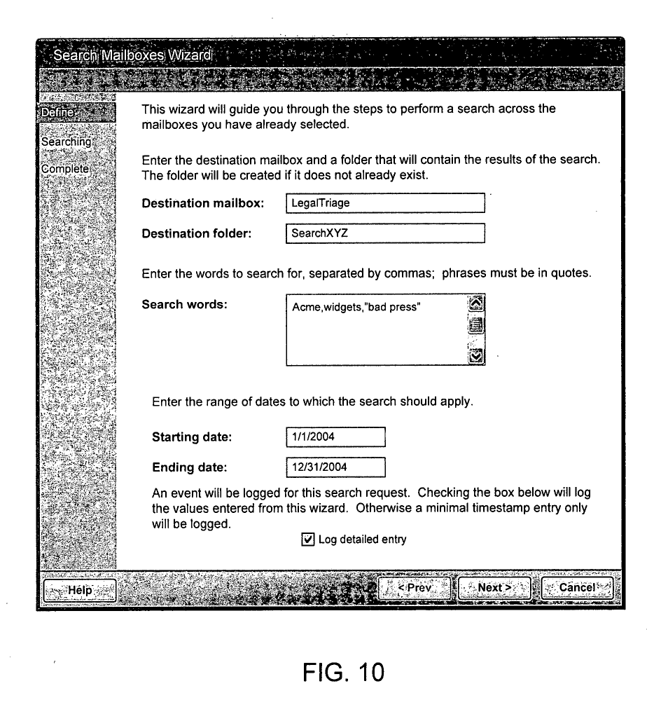

FIG. 10 depicts a user interface for a discovery tool that enables a system administrator to search through items across multiple mailboxes. The discovery tool may scan all messages and attachments. As shown, the system may enable the administrator to search on any number of message document properties. For example, the system may enable the administrator to perform full-text, keyword searches, and to restrict a search by Mailbox/DL and/or date range. The system enables the administrator to name the search, and to designate an “output mailbox” to which the results are to be exported. It should be understood that search results may be gathered in any number of ways, and that exporting search results to a mailbox is merely an example.

Search results may be “triaged” with Outlook/OWA, for example. OWA (Outlook Web Access) allows a client with a compatible browser to access Exchange Server folders. “Triage,” as that term is used herein, refers to a records management discovery process that sifts through matched items to determine which items are, in fact, items of interest. As the items are contained in a separate mailbox, a special review tool need not be provided. That is, a standard email client such as Outlook or OWA may be employed.

The user interface may also enable the administrator to request (by checking a box, for example) a detailed audit log associated with the search.

### EXAMPLE COMPUTING ENVIRONMENT

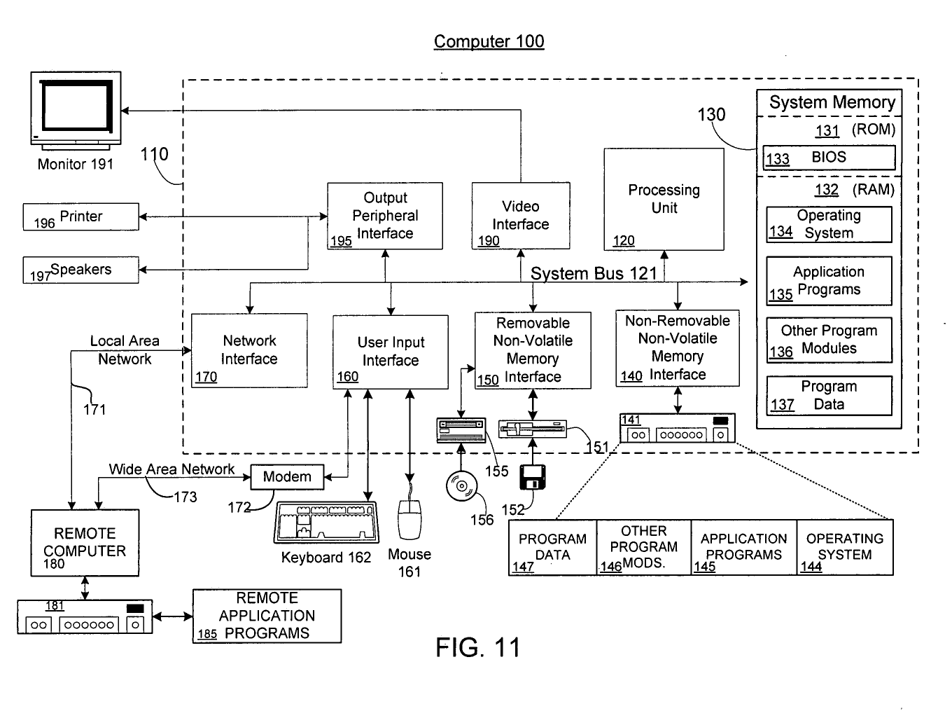

FIG. 11 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 11 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 11, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 11 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 11 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 11 provide storage of computer readable instructions, data structures, program modules and other data for the computer 110. In FIG. 11, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 11. The logical connections depicted in FIG. 11 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 11 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

What is claimed:

1. A method for management and administration of electronic document life-cycle management policies, the method comprising:
defining a document lifecycle enforcement policy for a grouping mechanism for grouping electronic documents; and
enforcing the document life-cycle management policy associated with the grouping mechanism.

2. The method of claim 1, further comprising:
creating a document lifecycle content setting for the grouping mechanism; and
linking the content setting for the grouping mechanism to a setting for a mailbox.

3. The method of claim 2, further comprising:
creating a folder in the mailbox, wherein the folder is the grouping mechanism.

4. The method of claim 3, further comprising pushing the folder to the mailbox.

5. The method of claim 4, further comprising:
automatically creating the selected one or more folders in the mailbox according to a predefined schedule.

6. The method of claim 2, wherein the content setting defines a way to control a lifespan of an electronic document of a specified type.

7. The method of claim 6, wherein the content setting defines a period after which the document expires.

8. The method of claim 6, wherein the content setting specifies an action to be taken when the document expires.

9. The method of claim 8, wherein the content setting causes the document to be copied automatically to a storage location.

10. The method of claim 1, further comprising:
providing a list of available organizational folders, wherein each said organizational folder has associated with it a respective content setting; and
enabling an end-user to select one or more of the available organizational folders.

11. The method of claim 10, further comprising:
creating the selected one or more organizational folders in the mailbox.

12. A method for management and administration of electronic document life-cycle management policies, the method comprising:
creating a new mailbox policy for a mailbox;
linking a mailbox folder to the mailbox policy;
automatically creating the mailbox folder in the mailbox according to a predefined schedule.

13. The method of claim 12, further comprising:
applying the mailbox policy to the mailbox.

14. The method of claim 12, wherein the mailbox folder is automatically created by a daemon process that is launched according to the predefined schedule.

15. The method of claim 12, wherein the daemon process also enforces a life-cycle management policy associated with the folder.

16. The method of claim 12, where in the mailbox includes an organizational folder for which a set of content settings is defined.

17. The method of claim 12, wherein the mailbox includes a default folder.

18. A system for management and administration of message life-cycle management policies, the system comprising:
a storage location associated with a mailbox, the mailbox defined by at least one folder having associated therewith a message lifecycle management policy; and
a service that enforces the message lifecycle management policy on message items contained within the folder.

19. The system of claim 18, further comprising:
a discovery tool for searching through message items across multiple mailboxes, and gathering the search results into a collection location.

20. The system of claim 18, wherein the discovery tool provides for searching on one or more properties of the message items.
